(19) United States
(12) Patent Application Publication
(10) Pub. No.: US 2006/0212523 A1
(43) Pub. Date: Sep. 21, 2006

(54) Policy based control of multiple message forwards

(75) Inventors: Fonda J. Daniels, Cary, NC (US); Ruthie D. Lyle, Durham, NC (US); Mary Ellen Zurko, Groton, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/085,647

(22) Filed: Mar. 21, 2005

(51) Int. Cl. G06F 15/16

(52) U.S. Cl. 709/206

(57) ABSTRACT

A method, system and apparatus for the policy based control of multiple message forwards. A method for policy based control of multiple message forwards can include reviewing a policy associated with a message to identify a set of recipients for a message. Responsive to a request to forward a substantially unmodified form of the message, the method also can include detecting based upon the reviewed policy an attempt to forward the substantially unmodified form of the message to a recipient who already has received the message.

### BACKGROUND OF THE INVENTION

1. Statement of the Technical Field

The present invention relates to electronic messaging and more particularly to the forwarding of a message multiple times to the same recipient.

2. Description of the Related Art

Electronic messaging represents the single most useful task accomplished over wide-scale computer communications networks. Some argue that in the absence of electronic messaging, the Internet would have amounted to little more than a science experiment. Today, electronic messaging seems to have replaced the ubiquitous telephone and fax machine for the most routine of interpersonal communications. As such, a variety of electronic messaging systems have arisen which range from real-time instant messaging systems and wireless text pagers to asynchronous electronic mail systems.

Electronic mail, a form of electronic messaging referred to in the art as e-mail, has proven to be the most widely used computing application globally. Though e-mail has been a commercial staple for several decades, due to the explosive popularity and global connectivity of the Internet, e-mail has become the preferred mode of communications, regardless of the geographic separation of communicating parties. Today, more e-mails are processed in a single hour than phone calls. Clearly, e-mail as a mode of communications has been postured to replace all other modes of communications save for voice telephony.

In reading electronic messages, it can be quite common to receive the same message multiple times form different sources. Message recipients often receive multiple copies of the same message for several reasons. For instance, users that forward received messages in most cases do not first identify those who already have received the message. Additionally, the “To:” or “cc:” field in an e-mail message can include a distribution list. Oftentimes, the distribution list can include so many designated recipients that it is not convenient to identify a particular recipient of a message. Moreover, access to the individual e-mail addresses which constitute the distribution list may not not available. Finally, in many cases, an e-mail address or a distribution list can be included as part of a “bcc:” field in consequence of which recipients of the message cannot view either.

Receiving the same message repeatedly from different sources can reduce the efficiency of the recipient as the recipient is required to view the same message multiple times. To do so can unnecessarily increase workload of the recipient. Moreover, the receipt of the same message multiple times can consume additional computing storage otherwise not required. To the extent that attachments are included as part of the message, the storage program can become particularly acute. Similarly, the repeated and unnecessary transmission of a message having large attachments can consume valuable network bandwidth to the detriment of other applications on the network.

### SUMMARY OF THE INVENTION

The present invention addresses the deficiencies of the art in respect to multiple message forwards and provides a novel and non-obvious method, system and apparatus for the policy based control of multiple message forwards. A method for policy based control of multiple message forwards can include reviewing a policy associated with a message to identify a set of recipients for a message. Responsive to a request to forward a substantially unmodified form of the message, the method also can include detecting based upon the reviewed policy an attempt to forward the substantially unmodified form of the message to a recipient who already has received the message.

In one aspect of the invention, the reviewing step can include reviewing a policy associated with a message to identify a set of recipients specified as a group for receiving a message. In another aspect of the invention, the reviewing step can include reviewing an Enterprise Privacy Authoring Language (EPAL) specified policy associated with a message to identify a set of recipients specified as a group for receiving a message. An EPAL policy defines lists of hierarchies of data-categories, user-categories, and purposes, and sets of privacy actions, obligations, and conditions. In yet another aspect of the invention, responsive to detecting an attempt to forward the message to a recipient who already has received the message, a forwarding of the message to the recipient can be blocked. Furthermore, the blocking of the forwarding of the message to the recipient can be logged.

A system for policy based control of multiple message forwards can include a message client and a policy processor coupled to the message client. The message client can be a message client selected from the group consisting of an e-mail client and an instant messenger client. The policy processor can be programmed to respond to a request to forward a substantially unmodified form of a received message by detecting, based upon a reviewed policy associated with the received message, an attempt to forward the substantially unmodified form of the received message to a recipient who already has received the message. The reviewed policy can be an EPAL specified policy.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system for policy-based control of multiple message forwards;

FIG. 2 is a pictorial illustration of a process for policy-based control of multiple message forwards; and,

FIG. 3 is a flow chart illustrating a process for policy-based control of multiple message forwards.

### DETAILED DESCRIPTION OF THE PREFERRED EMBODIMENTS

The present invention is a method, system and apparatus for the policy-based control of multiple message forwards. In accordance with the present invention, a set of messaging clients in a messaging network can be configured to process a message handling policy defined through a uniform message handling schema. The policy can specify a set of designated recipients for an associated message and the rights afforded to those recipients in manipulating the associated message. When received by a designated recipient, the forwarding of the unmodified form of the associated message can be limited by the messaging client to those designated recipients not specified within the policy as an originally designated recipient of the associated message.

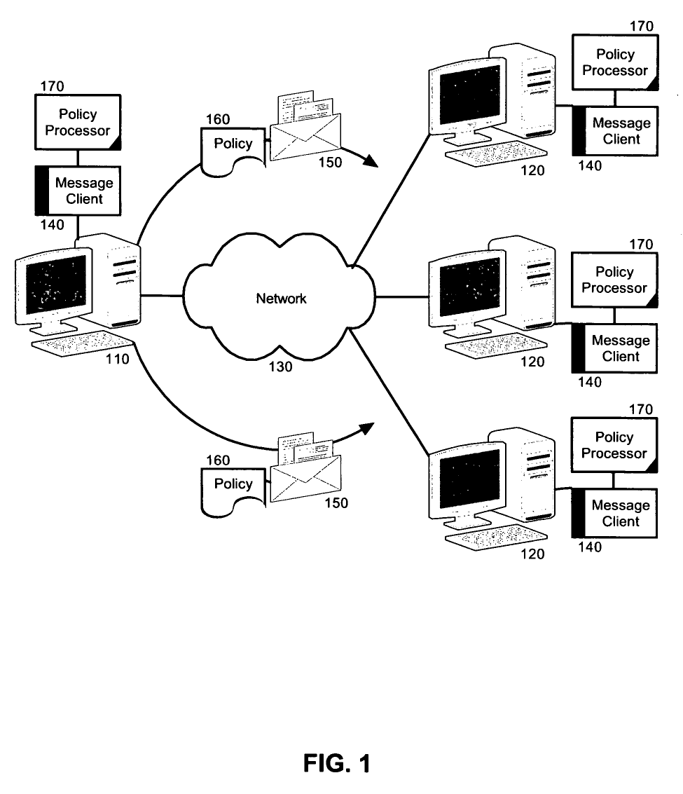

In further illustration, FIG. 1 is a schematic illustration of a system for policy-based control of multiple message forwards. The system can include a message author 110 coupled to one or more message recipients 120 over a data communications network 130. The author 110 can include a messaging client 140 configured to create, edit, transmit and receive electronic messages 150 including e-mail. Likewise, each of the recipients 120 can include a messaging client 140 configured to create, edit, transmit and receive electronic messages 150 including e-mail over the data communications network.

Importantly, each of the message clients 140 can be configured with a policy processor 170 programmed to process messaging policies 160 associated with the electronic messages 150. Each of the messaging policies 160 can specify a set of designated recipients for an associated one of the electronic messages 150. Each of the messaging policies 160 further can specify a set of limitations pertaining to the ability of a message recipient to interact with an associated one of the electronic messages 150. Finally, the messaging policies 160 can conform to a uniform messaging handling schema.

As an example, the messaging policies 160 can conform to EPAL. An EPAL policy defines lists of hierarchies of data-categories, user-categories, and purposes, and sets of privacy actions, obligations, and conditions. User-categories are the entities which can include users and groups that use collected data. Data-categories, by comparison, define different categories of collected data that are handled differently from a privacy perspective. Purposes model the intended service for which data is used. Actions model how the data is used and Obligations define actions that must be taken by the environment of EPAL. Finally, Conditions are Boolean expressions that evaluate the context.

These elements are then used to formulate privacy authorization rules that allow or deny actions on data-categories by user-categories for certain purposes under certain conditions while mandating certain obligations. In order to allow for general rules and exceptions, EPAL rules are sorted by descending precedence, for example., a rule about a particular employee can be inserted before the rule about the department in order to implement an exception.

Advantageously, responsive to an attempt by a message recipient 120 to forward an unmodified form of a received one of the electronic messages 150 to a new recipient, the policy processor 170 further can be programmed to inspect the policy 160 to determine whether the new recipient already had received the electronic message 150. If so, the policy processor 170 can undertake remedial measures which can include warning the user before forwarding the message, and quashing the operation, to name only a few. Also, a log of the remedial measure or measures can be maintained for the benefit of the user.

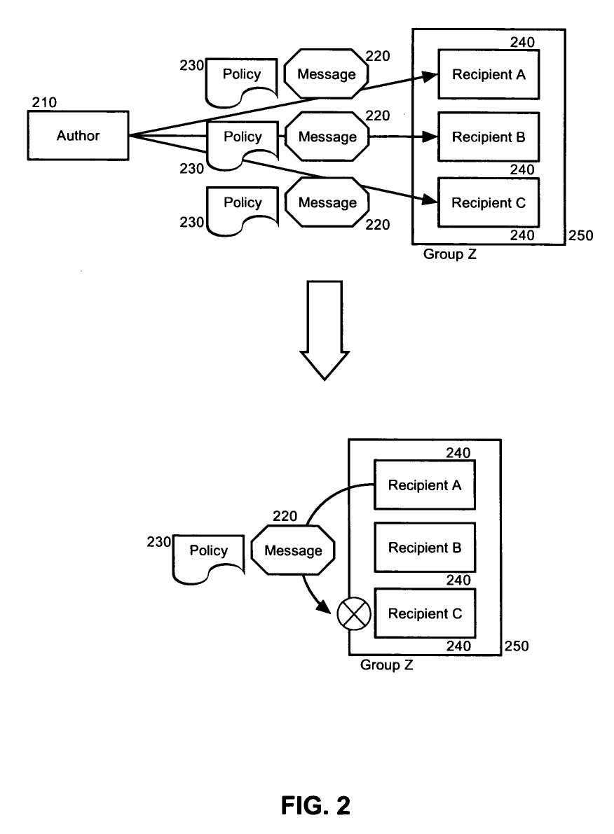

In more particular explanation, FIG. 2 is a pictorial illustration of an exemplary application of a process for policy-based control of multiple message forwards. As shown in FIG. 2, an author 210 can compose, modify or forward a message 220 to multiple recipients 240 (shown as Recipient A, Recipient B and Recipient C). Each of the recipients 240 can be specified within a policy 230 as belonging to a group 250. The policy 230 in turn can be associated with the message 220 so that the recipients 240 in the group 250 will receive the policy 230 along with the message 220.

Once received, the message 220 can be forwarded by a recipient 240 (for example, Recipient A) to other designated recipients including one or more recipients 240 in the group 250 (for example, Recipient C). In the course of forwarding the message 220 to another recipient 240 (for example, Recipient C) in the group 250, the policy 230 can be processed to determine that the designated recipient 240 (for example, Recipient C) within the group 250 already has received the message 220 previously from the author 210. Accordingly, remedial measures can be undertaken including blocking the forwarding of the message 220 to the designated recipient 240 (for example, Recipient C) within the group 250.

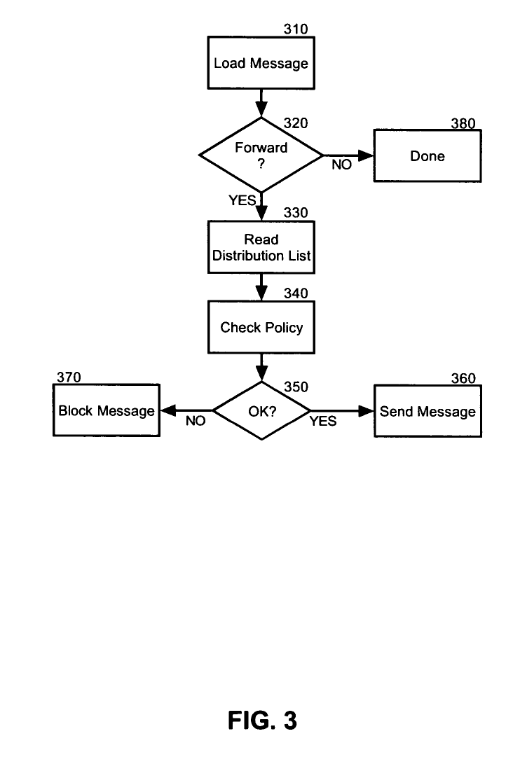

In more general illustration of the process of the invention, FIG. 3 is a flow chart illustrating a process for policy-based control of multiple message forwards. Beginning in block 310, a message can be loaded for processing. If in decision block 320 the loaded message is to be forwarded to one or more designated recipients, in block 330 the distribution list to receive the forwarded message can be read in and the policy can be checked in block 340. If in decision block 350 it is determined, based upon the policy, that one or more of the designated recipients in the distribution already has received the message in its unmodified form, in block 370 the message can be blocked to the designated recipients which already have received the message. Optionally, the blockage can be logged for the benefit of the sender.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for policy based control of multiple message forwards, the method comprising the steps of:
reviewing a policy associated with a message to identify a set of recipients for a message; and,
responsive to a request to forward a substantially unmodified form of said message, detecting based upon said reviewed policy an attempt to forward said substantially unmodified form of said message to a recipient who already has received said message.

2. The method of claim 1, wherein said reviewing step comprises the step of reviewing a policy associated with a message to identify a set of recipients specified as a group for receiving a message.

3. The method of claim 1, wherein said reviewing step comprises the step of reviewing an Enterprise Privacy Authoring Language (EPAL) specified policy associated with a message to identify a set of recipients specified as a group for receiving a message.

4. The method of claim 1, wherein said detecting step comprises the step of, responsive to a request to forward said message, detecting based upon said reviewed policy an attempt to forward said message to a recipient who already has received said message.

5. The method of claim 1, further comprising the step of, responsive to detecting an attempt to forward said message to a recipient who already has received said message, blocking a forwarding of said message to said recipient.

6. The method of claim 5, further comprising the step of logging said blocking of said forwarding of said message to said recipient.

7. A system for policy based control of multiple message forwards, the system comprising:
a message client; and,
a policy processor coupled to said message client and programmed to respond to a request to forward a substantially unmodified form of a received message by detecting based upon a reviewed policy associated with said received message an attempt to forward said substantially unmodified form of said received message to a recipient who already has received said message.

8. The system of claim 7, wherein said message client is a message client selected from the group consisting of an e-mail client and an instant messenger client.

9. The system of claim 7, wherein said reviewed policy is an Enterprise Privacy Authoring Language (EPAL) specified policy.

10. A machine readable storage having stored thereon a computer program for policy based control of multiple message forwards, the computer program comprising a routine set of instructions which when executed by a machine causes the machine to perform the steps of:
reviewing a policy associated with a message to identify a set of recipients for a message; and,
responsive to a request to forward a substantially unmodified form of said message, detecting based upon said reviewed policy an attempt to forward said substantially unmodified form of said message to a recipient who already has received said message.

11. The machine readable storage of claim 10, wherein said reviewing step comprises the step of reviewing a policy associated with a message to identify a set of recipients specified as a group for receiving a message.

12. The machine readable storage of claim 10, wherein said reviewing step comprises the step of reviewing an Enterprise Privacy Authoring Language (EPAL) specified policy associated with a message to identify a set of recipients specified as a group for receiving a message.

13. The machine readable storage of claim 10, wherein said detecting step comprises the step of, responsive to a request to forward said message, detecting based upon said reviewed policy an attempt to forward said message to a recipient who already has received said message.

14. The machine readable storage of claim 10, further comprising an additional set of instructions which when executed by the machine causes the machine to further perform the step of, responsive to detecting an attempt to forward said message to a recipient who already has received said message, blocking a forwarding of said message to said recipient.

15. The machine readable storage of claim 14, further comprising an additional set of instructions which when executed by the machine causes the machine to further perform the step of, logging said blocking of said forwarding of said message to said recipient.
